(19) United States
(12) Patent Application Publication
(10) Pub. No.: US 2010/0199760 A1
(43) Pub. Date: Aug. 12, 2010

(54) Method and Apparatus for Analysing Vehicle Wheels

(75) Inventor: Norbert Seitz, Grobenzell (DE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: AUTOBALANCE PLC., Stockholm (SE)

(21) Appl. No.: 12/599,914

(22) PCT Filed: May 14, 2008
(86) PCT No.: PCT/EP2008/055865

§ 371 Date: Apr. 20, 2010

(30) Foreign Application Priority Data
May 15, 2007 (DK) PA 2007 00733

(51) Int. Cl. G01M 1/16

(52) U.S. Cl. 73/460

(57) ABSTRACT

A method of analysing a vehicle wheel with a tyre, comprising rotating the vehicle wheel with a first number of revolutions for a first period of time, wherein a tread surface of the tyre is pressed with a first force against a first rotatable drum, the first force is measured with a first measuring device, and the first force is kept substantially constant; and rotating the vehicle wheel with a second number of revolutions for a second period of time, wherein the tread surface is pressed with a second force against the first drum or a second rotatable drum, and the second force is measured. An apparatus for analysing a vehicle wheel with a tyre, wherein the vehicle wheel is rotated with a first number of revolutions for a first period of time, wherein a tread surface of the tyre is pressed with a first force against a first rotatable drum, the first force is measured with a first measuring device, and the first force is kept substantially constant; and the vehicle wheel is rotated with a second number of revolutions for a second period of time, wherein the tread surface is pressed with a second force against the first drum or a second rotatable drum, and the second force is measured.

### FIELD OF THE INVENTION

Embodiments of the invention described herein relate generally to analysing vehicle wheels, and more particularly to a method and an apparatus for balancing and analysing vehicle wheels comprising pneumatic tyres and a viscous balancing substance.

### BACKGROUND OF THE INVENTION

EP patent application 0 281 252 and corresponding U.S. Pat. No. 4,867,792 disclose a thixotropic tyre balancing composition having a yield stress value between 30 Pa and 260 Pa being capable of balancing tyres by being able to flow under the influence of the vibrations induced when a heavy spot on the tyre hits the road surface. The balancing composition distributes itself in a wheel assembly consisting of a tyre mounted on a rim and having a heavy spot.

DE patent application 3823926 discloses a method and an apparatus for the analysis of production-dependent, circumferentially distributed non-uniformities of a vehicle tyre, wherein a predetermined non-uniformity is analysed by successively mounting a plurality of tyres on the measuring rim in each case with the point having the non-uniformities to be analysed in the same respective angular rotation position, storing the magnitudes of the non-uniformities of each tyre measured around its circumference and adding them up. The method is suitable, inter alia, for the quality control of motor vehicle tyres.

U.S. Pat. No. 5,431,726 discloses a tyre gel balancing composition having a Storage modulus of between 3000 and 15000 Pa and a Specific Gravity less than 1000 kg/m³ in the temperature range between −20° C. and +90° C. and being capable of balancing tyres by being able to flow under the vibrations caused by imbalance in a wheel assembly.

PCT patent application WO 98/52009 and corresponding DE patent application 197 19 886 disclose a method for balancing automobile wheel assemblies comprising pneumatic tyres, comprising introducing a viscous balancing composition into the tyre; mounting the wheel on a rotatable assembly; pressing a rotatable drum and the tread surface of the wheel in the rotatable assembly against one another with a static force F, the axes of rotation of the drum and the wheel assembly being essentially parallel; and driving the drum and/or the wheel assembly to rotation for a time period T; the force F and the time T being sufficient to cause the balancing composition to be distributed inside the tyre, thereby balancing the wheel assembly. The method may preferably be carried out on an apparatus comprising a rotatable assembly on which a wheel assembly comprising a rim and a pneumatic tyre may be mounted; a rotatably mounted drum having an axis of rotation essentially parallel to that of the rotatable wheel assembly, the axes drum and/or the rotatable wheel assembly being capable of being moved in a direction towards and away from one another; driving means for rotating the rotatable wheel assembly and/or the drum; spring means and dampening means for providing static force and dampening in a direction between the axes of rotation of the drum and the rotatable wheel assembly, respectively, and essentially at right angles to said axes; and spring means and/or dampening means mounted between the axis of rotation of the rotatable wheel assembly and the ground and/or between the axis of rotation of the drum and the ground.

DE patent application 198 57 646 discloses a method for balancing tyres by introducing a balancing substance inside the tyre, comprising placing a substance with definite properties, shape, geometry and weight inside the tyre; and moving to the point of imbalance by rotating the tyre. The method may also be used for balancing other rotating objects.

DE patent application 198 53 691 discloses a method for introducing tyre-balancing substance as internal circumferential gel bead. The substance characteristic, shape, weight, geometry and its deposition locations are defined. The internal surface of the tyre exhibits defined shape and geometry. One or more endless strands may be employed. Strand cross section may be circular, semicircular, flattened, triangular, quadrilateral or polygonal. The one or more strands are distributed over the entire circumference, or just part of it, or both types of distribution take place. Strand portions are applied opposite the valve, when mounted on the rim. They are applied at or away from the equatorial plane, symmetrically, or else asymmetrically. The substance is injected through the valve in set quantity. A gel with a defined viscosity, thixotropy, long term stability, and compatibility with the tyre's inner surface is used. The tyre has one or more circumferential grooves, optionally between beads, to accept the substance.

DE patent application 199 16 564 discloses a method and an apparatus for distributing weights in tyres, involving applying weight material to the inner liners of tyres. Tyre inhomogeneity is measured on a conventional machine before the tyre is on the rim and the measurement values are fed to a computer, which determines the quantity of weight material to be applied and where to apply it to compensate the inhomogeneity and which is coupled to a machine for applying weight material to the required place in the required quantity.

A viscous, for example thixotropic, balancing substance, for example composition, may be used for balancing a vehicle wheel comprising a tyre. The balancing substance may be inserted into the tyre before the tyre is mounted to a rim, or through a valve. For balancing the vehicle wheel, the substance may be distributed by driving a vehicle comprising the vehicle wheel, or mounting the vehicle wheel on a rotatable assembly; pressing a rotatable drum and a tread surface of the vehicle wheel in the rotatable assembly against one another with a static force; and driving the drum and/or the vehicle wheel to rotation for a time period; the force and the time being sufficient to cause the balancing composition to be distributed inside the tyre, thereby balancing the vehicle wheel.

If the tyre is according to its specification and, thus, does not have a significant geometrical abnormality, such as axial run-out or radial run-out, or significant variations in axial, radial or tangential stiffness, the balanced vehicle wheel provides, from a subjective view, for a comfortable driving experience.

However, vehicle manufactures and also repair shops need an objective verification proofing that the vehicle wheel is balanced, or determining a residual unbalance of the vehicle wheel.

Conventional methods and apparatuses for balancing conventional vehicle wheels, i.e. vehicle wheels balanced with metal, e.g. zinc, weights, cannot be used for analysing a vehicle wheel balanced with a viscous balancing substance as the tyre may be pressurized, but unloaded.

For these and other reasons, there is a need for the invention as set forth in the following in the embodiments.

### SUMMARY OF THE INVENTION

The invention aims to provide a method and an apparatus for analysing a vehicle wheel with a tyre.

An aspect of the invention is a method of analysing a vehicle wheel with a tyre, comprising rotating the vehicle wheel with a first number of revolutions for a first period of time, wherein a tread surface of the tyre is pressed with a first force against a first rotatable drum, the first force is measured with a first measuring device, and the first force is kept substantially constant; and rotating the vehicle wheel with a second number of revolutions for a second period of time, wherein the tread surface is pressed with a second force against the first drum or a second rotatable drum, and the second force is measured.

Another aspect of the invention is an apparatus for analysing a vehicle wheel with a tyre, wherein the vehicle wheel is rotated with a first number of revolutions for a first period of time, wherein a tread surface of the tyre is pressed with a first force against a first rotatable drum, the first force is measured with a first measuring device, and the first force is kept substantially constant; and the vehicle wheel is rotated with a second number of revolutions for a second period of time, wherein the tread surface is pressed with a second force against the first drum or a second rotatable drum, and the second force is measured.

### BRIEF DESCRIPTION OF THE SEVERAL VIEWS OF THE DRAWING(S)

While the specification concludes with claims particularly pointing out and distinctly claiming that which is regarded as the invention, a more particular description of the invention will be rendered by reference to specific embodiments thereof, which are depicted in the appended drawings, in order to illustrate the manner in which embodiments of the invention are obtained. Understanding that these drawings depict only typical embodiments of the invention, that are not necessarily drawn to scale, and, therefore, are not to be considered limiting of its scope, embodiments will be described and explained with additional specificity and detail through use of the accompanying drawings in which:

FIG. 1 shows an apparatus for analysing a vehicle wheel according to an embodiment of the invention;

FIG. 2 shows an apparatus for analysing a vehicle wheel according to another embodiment of the invention; and

FIG. 3 shows measuring devices for measuring forces in an apparatus for analysing a vehicle wheel according to embodiments of the invention.

### DETAILED DESCRIPTION OF THE INVENTION

In the following detailed description of the embodiments, reference is made to the accompanying drawings which form a part hereof and show, by way of illustration, specific embodiments in which the invention may be practiced. In the drawings, like numerals describe substantially similar components throughout the several views. The embodiments are intended to describe aspects of the invention in sufficient detail to enable those of skill in the art to practice the invention. Other embodiments may be utilized and structural, logical or electrical changes or combinations thereof may be made without departing from the scope of the invention. Moreover, it is to be understood, that the various embodiments of the invention, although different, are not necessarily mutually exclusive. For example, a particular feature, structure or characteristic described in one embodiment may be included within other embodiments. Furthermore, it is to be understood, that embodiments of the invention may be implemented using different technologies. Also, the term “exemplary” is merely meant as an example, rather than the best or optimal. The following detailed description is, therefore, not to be taken in a limiting sense, and the scope of the invention is defined only by the appended claims, along with the full scope of equivalents to which such claims are entitled.

Reference will be made to the drawings. In order to show the structures of the embodiments most clearly, the drawings included herein are diagrammatic representations of inventive articles. Thus, actual appearance of the fabricated structures may appear different while still incorporating essential structures of embodiments. Moreover, the drawings show only the structures necessary to understand the embodiments. Additional structures known in the art have not been included to maintain clarity of the drawings. It is also to be understood, that features and/or elements depicted herein are illustrated with particular dimensions relative to one another for purposes of simplicity and ease of understanding, and that actual dimensions may differ substantially from that illustrated herein.

In the following description and claims, the terms “include”, “have”, “with” or other variants thereof may be used. It is to be understood, that such terms are intended to be inclusive in a manner similar to the term “comprise”.

In the following description and claims, the terms “coupled” and “connected”, along with derivatives such as “communicatively coupled” may be used. It is to be understood, that these terms are not intended as synonyms for each other. Rather, in particular embodiments, “connected” may be used to indicate, that two or more elements are in direct physical or electrical contact with each other. However, “coupled” may also mean that two or more elements are not in direct contact with each other, but yet still co-operate or interact with each other.

In the following description and claims, terms, such as “upper”, “lower”, “first”, “second”, etc., may be only used for descriptive purposes and are not to be construed as limiting. The embodiments of a device or article described herein can be manufactured, used, or shipped in a number of positions and orientations.

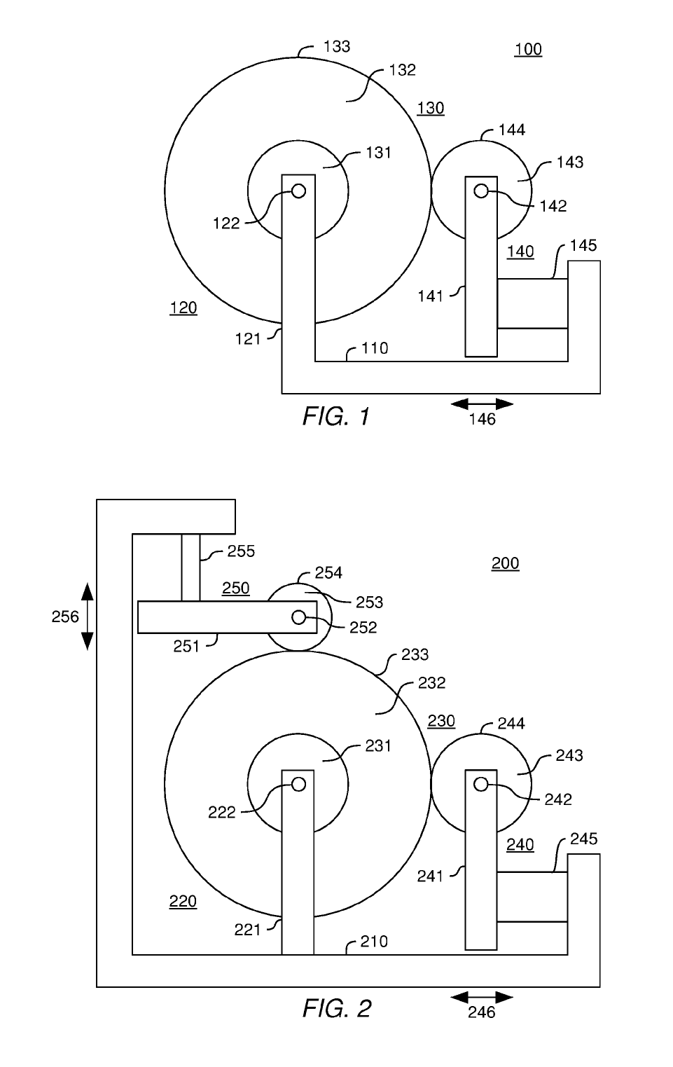

FIG. 1 shows an apparatus 100 for analysing a vehicle wheel 130 according to an embodiment of the invention.

The apparatus 100 may comprise a base 110, a rotatable assembly 120 coupled to the base 110, a drum first assembly 140 coupled to the base 110 and a first measuring device 145.

The rotatable assembly 120 comprises a first support element 121 and a first rotatable axis 122. The first support element 121 may be connected to the base 110 as shown in FIG. 1 or movably, for example pivotably, rotatably or slidably, coupled to the base 110 (not shown). The first axis 122 may receive and hold the vehicle wheel 130 to be analysed. The vehicle wheel 130 may be arranged vertically, horizontally or inclined by a certain angle. The vehicle wheel 130 comprises a rim 131 and a tyre 132 with a tread surface 133. The tyre 132 may be a pneumatic tyre and comprise a pressurized gas or mixture of gases, for example atmospheric air (not shown). The vehicle wheel 130 may be intended for a motorized vehicle, for example a car, bus, light truck, heavy truck or motorcycle, or an aircraft.

The first drum assembly 140 comprises a second support element 141, a second rotatable axis 142 and a first drum or roller 143 with a first outer shell surface 144. The first outer shell surface 144 and the tread surface 133 may be brought in contact and pressed against one another with force. Thus, the second support element 141 may be slidably coupled to the base 110 in directions indicated by an arrow 146 shown in FIG. 1 or movably, for example pivotably or rotatably, coupled, or connected to the base 110 (not shown). A diameter of the first drum 143 may be approximately between 0.05 m and 5 m. A ratio of the diameter of the first drum 143 to a diameter of the vehicle wheel 130 may be approximately between 0.1 and 10, for example approximately 1. The first drum 143 may be substantially solid or hollow. If the first drum is hollow and the ratio of the diameter of the first drum to the diameter of the vehicle wheel 130 is greater than 1, the vehicle wheel 130 may be arranged inside the hallow first drum, and an inner shell surface of the hallow first drum and the tread surface 133 may be brought in contact (not shown). The first drum may also be an endless belt passing around wheels, for example a caterpillar (not shown).

The apparatus 100 may further comprise a first actuator (not shown). The first actuator may be coupled to the rotatable assembly 120 or the first drum assembly 140. The first actuator may produce the force for pressing the first outer shell surface 144 and the tread surface 133 against one another in a first contact area. The first actuator may be electrically, hydraulically or pneumatically actuated or actuated by any suitable means. The first actuator may be coupled to a control unit (not shown). Alternatively, the force may be produced by any suitable means, for example a spring or weight, providing a similar effect (not shown).

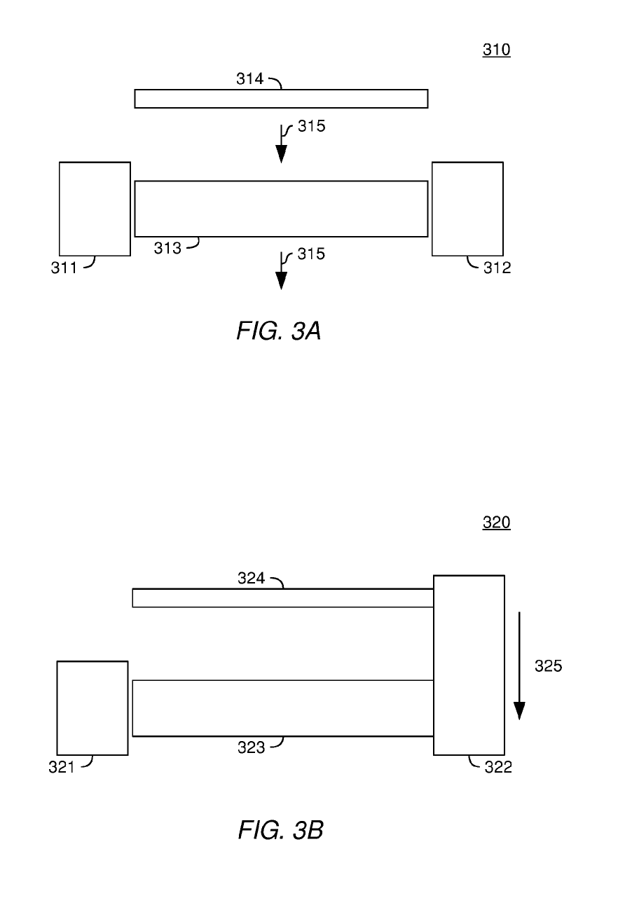

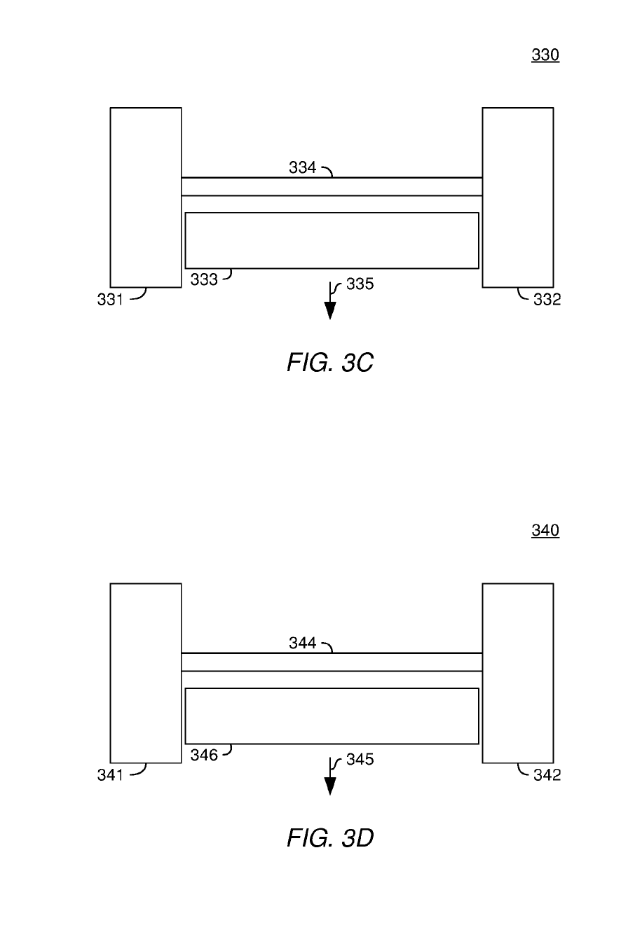

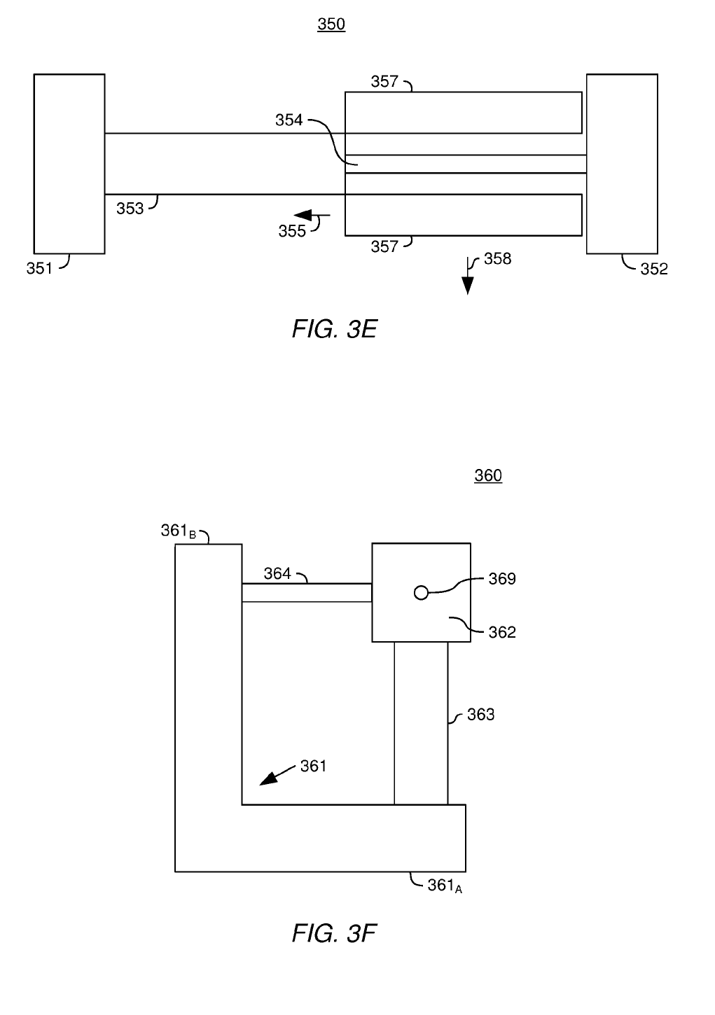

The first measuring device 145 measures the force directly or indirectly. The first measuring device 145 may measure force, bending or pressure, for example. The first measuring device 145 may comprise a force measuring device, for example a strain gauge, magneto-elastic sensor, piezo-electric sensor, oscillating-crystal sensor, or any suitable means. The first measuring device 145 may be serially arranged or arranged in parallel with other sensors or gauging members. The measuring device 145 may be selectively operable or switchable between measuring ranges. The first measuring device 145 may be coupled to the control unit. The measuring device 145 will be described in more details with reference to FIG. 3.

The first measuring device 145 may be coupled the first drum assembly 140. The first measuring device 145 may be connected to the second support element 141 and the base 110 as shown in FIG. 1. The first measuring device 145 may also be connected to the second axis 142, or arranged on the first outer surface 144 (not shown). Thus, the first measuring device 145 is assigned to the first drum 143. The first measuring device 145 may also be connected to the first support element 121 or the first axis 122 (not shown). Thus, the first measuring device 145 may be assigned to the vehicle wheel 130.

The apparatus 100 may further comprise a motor (not shown). The motor rotates the vehicle wheel 130 clockwise or count-clockwise, directly or indirectly. The motor may be coupled to the vehicle wheel 130 or the first drum 143. Thus, the vehicle wheel 130 or the first drum 143 or both may be powered. The motor may be directly connected or coupled via a belt, a chain, a gear, or any suitable means providing similar functionality (not shown). The motor may be electrically, hydraulically or pneumatically powered or powered by any suitable means.

The apparatus 100 may further comprise an acceleration sensor (not shown). The acceleration sensor may measure vertical acceleration or horizontal acceleration in the first contact area. The acceleration sensor may also be coupled to the control unit.

A method of analysing the vehicle wheel 130 comprises rotating the vehicle wheel 130 with a first number of revolutions for a first period of time, wherein the tread surface 133 is pressed with a first force against the first drum 143, the first force is measured with the first measuring device 145, and the first force is kept substantially constant; and rotating the vehicle wheel 130 with a second number of revolutions for a second period of time, wherein the tread surface 133 is pressed with a second force against the first drum 143, and the second force is measured.

The vehicle wheel 130 may further comprise a viscous, for example thixotropic, balancing substance within the tyre 132. During rotating the vehicle wheel 130 with the first number of revolutions and the first force corresponding with a partial contact force of a vehicle the balancing substance is distributed in the tyre, such that the vehicle wheel is balanced except for a residual unbalance. The method may further comprise determining the residual unbalance from the second force. However, the second force may be less than the first force. In more details, the residual unbalance and the corresponding second force are substantially smaller than the first force.

The first number of revolutions may be approximately between 15 1/s and 55 1/s, for example approximately between 25 1/s and 45 1/s, preferably approximately 35 1/s. A first peripheral speed, at the tread surface 133, is a function of the diameter of the vehicle wheel 130 times pi times the first number of revolutions. The corresponding first peripheral speed may be approximately between 100 km/h (about 28 m/s) and 300 km/h (about 83 m/s), for example approximately between 150 km/h (about 42 m/s) and 250 km/h (about 69 m/s), preferably approximately 200 km/h (about 56 m/s). The first period of time may last approximately between 1 s and 200 s, for example approximately between 5 s and 50 s, preferable approximately between 10 s and 20 s. The first force may amount to approximately between 100 N and 10 kN, for example approximately between 200 N und 5 kN, preferably approximately between 500 N und 2 kN. The first force may be measured with a first accuracy of approximately 10 N.

The second number of revolutions may be approximately between 15 1/s and 35 1/s, for example approximately between 25 1/s and 32 1/s. A corresponding second peripheral speed may be approximately between 100 km/h (about 28 m/s) and 200 km/h (about 56 m/s), for example approximately between 150 km/h (about 42 m/s) and 180 km/h (about 50 m/s). The second period of time may last approximately between 1 s and 100 s, for example approximately between 5 s and 50 s, preferable approximately between 10 s and 20 s. The second force amounts to approximately between 1 N und 5 kN, for example approximately between 5 N und 1 kN, preferably approximately between 20 N und 200 N. The second force may be measured with a second accuracy of approximately 1 N. The second force may be measured with the first measuring device 145.

The first measuring device 145 may be selectively operable to measure the first force. The first measuring device 145 may be switchable between a first measuring range and a second measuring range.

FIG. 2 shows an apparatus 200 for analysing a vehicle wheel 230 according to another embodiment of the invention.

The apparatus 200 may comprise a base 210, a rotatable assembly 220 coupled to the base 210, a first drum assembly 240 coupled to the base 210, a first measuring device 245, and a second drum assembly 250 coupled to the base 210.

The rotatable assembly 220 comprises a first support element 221 and a first rotatable axis 222. The first support element 221 may be connected to the base 210 as shown in FIG. 2 or movably, for example pivotably, rotatably or slidably, coupled to the base 210 (not shown). The first axis 222 may receive and hold the vehicle wheel 230 to be analysed. The vehicle wheel 230 may be arranged vertically, horizontally or inclined by a certain angle. The vehicle wheel 230 comprises a rim 231 and a tyre 232 with a tread surface 233. The tyre 232 may be a pneumatic tyre and comprise a pressurized gas or mixture of gases, for example atmospheric air (not shown). The vehicle wheel 230 may be intended for a motorized vehicle, for example a car, bus, light truck, heavy truck or motorcycle, or an aircraft.

The first drum assembly 240 comprises a second support element 241, a second rotatable axis 242 and a first drum or roller 243 with a first outer shell surface 244. The first outer shell surface 244 and the tread surface 233 may be brought in contact and pressed against one another with force. Thus, the second support element 241 may be slidably coupled to the base 210 in directions indicated by an arrow 246 shown in FIG. 2 or movably, for example pivotably or rotatably, coupled, or connected to the base 210 (not shown). A diameter of the first drum 243 may be approximately between 0.05 m and 5 m. A ratio of the diameter of the first drum 243 to a diameter of the vehicle wheel 230 may be approximately between 0.1 and 10, for example approximately 1. The first drum 243 may be substantially solid or hollow. If the first drum is hollow and the ratio of the diameter of the first drum to the diameter of the vehicle wheel 230 is greater than 1, the vehicle wheel 230 may be arranged inside the hallow first drum, and a first inner shell surface of the hallow first drum and the tread surface 233 may be brought in contact (not shown). The first drum may also be an endless belt passing around wheels, for example a caterpillar (not shown).

The apparatus 200 may further comprise a first actuator (not shown). The first actuator may be coupled to the rotatable assembly 220 or the first drum assembly 240. The first actuator may produce the force for pressing the first outer shell surface 244 and the tread surface 233 against one another in a first contact area. The first actuator may be electrically, hydraulically or pneumatically actuated or actuated by any suitable means. The first actuator may be coupled to a control unit (not shown). Alternatively, the force may be produced by any suitable means, for example a spring or weight, providing a similar effect (not shown).

The first measuring device 245 measures the force directly or indirectly. The first measuring device 245 may measure force, bending or pressure, for example. The first measuring device 245 may comprise a force measuring device, for example a strain gauge, magneto-elastic sensor, piezo-electric sensor, oscillating-crystal sensor, or any suitable means. The first measuring device 245 may be serially arranged or arranged in parallel with other sensors or gauging members. The measuring device 245 may be selectively operable or switchable between measuring ranges. The first measuring device 245 may be coupled to the control unit. The measuring device 245 will be described in more details with reference to FIG. 3.

The first measuring device 245 may be coupled the first drum assembly 240. The first measuring device 245 may be connected to the second support element 241 and the base 210 as shown in FIG. 2. The first measuring device 245 may also be connected to the second axis 242, or arranged on the first outer surface 244 (not shown). Thus, the first measuring device 245 is assigned to the first drum 243. The first measuring device 245 may also be connected to the first support element 221 or the first axis 222 (not shown). Thus, the first measuring device 245 may be assigned to the vehicle wheel 230.

The second drum assembly 250 comprises a third support element 251, a third rotatable axis 252 and a second drum or roller 253 with a second outer shell surface 254. The first outer shell surface 254 and the tread surface 233 may be brought in contact and pressed against one another with force. Thus, the third support element 251 may be slidably coupled to the base 210 in directions indicated by an arrow 256 shown in FIG. 2 or movably, for example pivotably or rotatably, coupled, or connected to the base 210 (not shown). A diameter of the second drum 253 may be approximately between 0.05 m and 5 m. A ratio of the diameter of the second drum 253 to a diameter of the vehicle wheel 230 may be approximately between 0.1 and 10, for example approximately 1. The second drum 253 may be substantially solid or hollow. If the first drum is hollow and the ratio of the diameter of the first drum to the diameter of the vehicle wheel 230 is greater than 1, the second drum may be arranged, together with the vehicle wheel 230, inside the hallow first drum, and the first outer shell surface of the second drum and the tread surface 233 may be brought in contact (not shown). If the second drum is hollow and the ratio of the diameter of the second drum to the diameter of the vehicle wheel 230 is greater than 1, the vehicle wheel 230 may be arranged inside the hallow second drum, and a second inner shell surface of the hallow second drum and the tread surface 233 may be brought in contact (not shown). The second drum may also be an endless belt passing around wheels, for example a caterpillar (not shown). The second drum assembly 250 may be arranged, with regards to the first axis 222, perpendicular to the first drum assembly 240 as shown in FIG. 2, opposite to the first drum assembly 240 (not shown) or at any suitable angle to the first drum assembly 240 (not shown). Thus, if the second drum assembly 250 is arranged, with regards to the first axis 222, perpendicular to the first drum assembly 240 the second force acts in a rotational plane of the vehicle wheel 230 perpendicularly to the first force.

The apparatus 200 may further comprise a second actuator (not shown). The second actuator may be coupled to the rotatable assembly 220 or the second drum assembly 240. The second actuator may produce the force for pressing the second outer shell surface 254 and the tread surface 233 against one another in a second contact area. The second actuator may be electrically, hydraulically or pneumatically actuated or actuated by any suitable means. The second actuator may also be coupled to the control unit. Alternatively, the force may be produced by any suitable means, for example a spring or weight, providing a similar effect (not shown).

The apparatus 200 may further comprise a second measuring device 255. The second measuring device 255 may measure the force directly or indirectly. The second measuring device 255 may measure force, bending or pressure, for example. The second measuring device 255 may comprise a force measuring device, for example a strain gauge, magneto-elastic sensor, piezo-electric sensor, oscillating-crystal sensor, or any suitable means. The second measuring device 255 may be serially arranged or arranged in parallel with other sensors or gauging members, for example the first measuring device 245. The second measuring device 245 may be selectively operable or switchable between measuring ranges. The second measuring device 255 may be coupled to the control unit. The measuring device will be described in more details with reference to FIG. 3.

The second measuring device 255 may be coupled the second drum assembly 250. The second measuring device 255 may be connected to the third support element 251 and the base 210 as shown in FIG. 2. The second measuring device 255 may also be connected to the third axis 252, or arranged on the second outer surface 254 (not shown). Thus, the second measuring device 255 is assigned to the second drum 253. The second measuring device 255 may also be connected to the first support element 221 or the first axis 222 (not shown). Thus, the second measuring device 255 may be assigned to the vehicle wheel 230. The second measuring device 255 may also be coupled to the first drum assembly 240. The second measuring device 255 may be connected to the second support element 241 and the base 210 (not shown). The second measuring device 255 may also be connected to the second axis 242, or arranged on the first outer surface 244 (not shown). Thus, the second measuring device 255 may be assigned to the first drum 243.

The apparatus 200 may further comprise a motor (not shown). The motor rotates the vehicle wheel 230 clockwise or count-clockwise, directly or indirectly. The motor may be coupled to the vehicle wheel 230, the first drum 243 or the second drum 253. Thus, the vehicle wheel 230, the first drum 243, the second drum 253, or two or all of them may be powered. The motor may be directly connected or coupled via a belt, a chain, a gear, or any suitable means providing similar functionality (not shown). The motor may be electrically, hydraulically or pneumatically powered or powered by any suitable means.

The apparatus 200 may further comprise an acceleration sensor (not shown). The acceleration sensor may measure vertical acceleration or horizontal acceleration in the first or second contact area. The acceleration sensor may also be coupled to the control unit.

A method of analysing the vehicle wheel 230 comprises rotating the vehicle wheel 230 with a first number of revolutions for a first period of time, wherein the tread surface 233 is pressed with a first force against the first drum 243, the first force is measured with the first measuring device 245, and the first force is kept substantially constant; and rotating the vehicle wheel 230 with a second number of revolutions for a second period of time, wherein the tread surface 233 is pressed with a second force against the second drum 253, and the second force is measured.

The vehicle wheel 230 may further comprise a viscous, for example thixotropic, balancing substance within the tyre 232. During rotating the vehicle wheel 230 with the first number of revolutions and the first force corresponding with a partial contact force of a vehicle the balancing substance is distributed in the tyre, such that the vehicle wheel is balanced except for a residual unbalance. The method may further comprise determining the residual unbalance from the second force. However, the second force may be less than the first force. In more details, the residual unbalance and the corresponding second force are substantially smaller than the first force.

The first number of revolutions may be approximately between 15 1/s and 55 1/s, for example approximately between 25 1/s and 45 1/s, preferably approximately 35 1/s. A first peripheral speed, at the tread surface 233, is a function of the diameter of the vehicle wheel 230 times pi times the first number of revolutions. The corresponding first peripheral speed may be approximately between 100 km/h (about 28 m/s) and 300 km/h (about 83 m/s), for example approximately between 150 km/h (about 42 m/s) and 250 km/h (about 69 m/s), preferably approximately 200 km/h (about 56 m/s). The first period of time may last approximately between 1 s and 200 s, for example approximately between 5 s and 50 s, preferable approximately between 10 s and 20 s. The first force may amount to approximately between 100 N and 10 kN, for example approximately between 200 N und 5 kN, preferably approximately between 500 N und 2 kN. The first force may be measured with a first accuracy of approximately 10 N.

The second number of revolutions may be approximately between 15 1/s and 35 1/s, for example approximately between 25 1/s and 32 1/s. A corresponding second peripheral speed may be approximately between 100 km/h (about 28 m/s) and 200 km/h (about 56 m/s), for example approximately between 150 km/h (about 42 m/s) and 180 km/h (about 50 m/s). The second period of time may last approximately between 1 s and 100 s, for example approximately between 5 s and 50 s, preferable approximately between 10 s and 20 s. The second force amounts to approximately between 1 N und 5 kN, for example approximately between 5 N und 1 kN, preferably approximately between 20 N und 200 N. The second force may be measured with a second accuracy of approximately 1 N. The second force may be measured with the first measuring device 245. The second force may be measured with the first measuring device 245 or second measuring device 255.

The first measuring device 245 may be selectively operable to measure the first force. The first measuring device 245 may be switchable between a first measuring range and a second measuring range. A first basic accuracy of the first measuring device 245 may be less than a second basic accuracy of the second measuring device 255.

The second measuring device 255 may be selectively operable to measure the second force. The second measuring device 255 may be switchable between a third measuring range and a fourth measuring range.

If the first force represents a contact force, for example of a loaded vehicle, and the second force represents a residual unbalance, the first force and the second force are of different magnitudes. If, for example, the first force amounts to approximately 5 kN and the second force amounts to approximately 5 N, the second force is smaller than the first force by a factor of 1000. However, while it may be necessary to measure the second force with a second accuracy of approximately 1 N, a measuring device providing this necessary accuracy may not provide a measuring range comprising, for example, 5 kN. Thus, if subjected to the first force, it may experience overstraining and, possibly, permanent damage. A measuring device providing this necessary measuring range may not provide this accuracy necessary for determining the residual unbalance.

In apparatus 200 for analysing a vehicle wheel as shown in FIG. 2 comprising the first drum assembly 240 and the second drum assembly 250, the first measuring device 245 measuring the first force may be coupled the first drum assembly 240, and the second measuring device 255 measuring the second force may be coupled the second drum assembly 250. Thus, the first measuring device 245 may provide the necessary measuring range for measuring the first force, i.e. contact force, with an appropriate accuracy, and the second measuring device 255 may provide the necessary accuracy for measuring the second force, i.e. residual unbalance, in an appropriate measuring range.

FIG. 3 shows measuring devices for measuring forces in an apparatus for analysing a vehicle wheel according to embodiments of the invention.

The measuring devices may comprise a force measuring device, for example a strain gauge, magneto-elastic sensor, piezo-electric sensor, oscillating-crystal sensor, or any suitable means.

In a strain gauge, for example, an electrical resistance of a wire changes under influence of strain. If strain is applied to the wire, a length of the wire increases and a diameter of the wire decreases. The wire is made of a material, for example metal, such as Constantan, Karma and platinum-iridium, having a specific electrical resistance. Thus, if the length increases and the diameter decreases, the electrical resistance increases. For measuring force the strain gauge may be affixed, for example bonded or glued, along a rod having a cross section and a length. The rod is made of a material, for example metal, such as steel, having an elastic modulus. If force is applied to the rod, the length of the rod increases, within an elastic range, proportionally to the force, and, thus, the electrical resistance of the wire also increases. A force measuring device comprising a strain gauge and a rod provides a typical measuring range of ±5%, i.e. an elastic elongation of ±5 μm/m. Strain, i.e. force, resulting in an elongation of 1% or more, i.e. permanent elongation, damages the strange gauge.

FIG. 3a) shows a measuring device 310 comprising a first support member 311, a second support member 312, a first force measuring device 313 and a second force measuring device 314. A first force, i.e. contact force, and a second force, i.e. residual unbalance, may act from the first support member 311 towards the second support member 312 or vice versa. The first force measuring device 313 provides a measuring range and an accuracy for measuring the first force, and the second force measuring device 314 provides a measuring range and an accuracy for measuring the second force. For measuring the first force the first force measuring device 313 is placed between the first support member 311 and the second support member 312 as shown in FIG. 3a). For measuring the second force the second force measuring device 314 is placed in direction of arrow 315 between the first support member 311 and the second support member 312 (not shown). Thus, the first force measuring device 313 may be selected for measuring the first force, and the second force measuring device 314 may be selected for measuring the second force.

The measuring device 310 may further comprise an actuator (not shown). The actuator may be coupled to the first force measuring device 313 and the second force measuring device 314, and may move the first force measuring device 313 or the second force measuring device 314 between the first support member 311 and the second support member 312.

The measuring device 310 may further comprise one or more interlocks (not shown). An interlock may releasably couple the first force measuring device 313 or second force measuring device 314 to the first support member 311 or second support member 312, respectively. For example, the first force measuring device 313 and second force measuring device 314, respectively, may dovetail with the first support member 311 and second support member 312 when moved between the first support member 311 and the second support member 312.

FIG. 3b) shows a measuring device 320 comprising a first support member 321, a second support member 322, a first force measuring device 323 and a second force measuring device 324. The first force measuring device 323 and the second force measuring device 323 are coupled, substantially in parallel, to the second support member 322. A first force, i.e. contact force, and a second force, i.e. residual unbalance, may act from the first support member 321 towards the second support member 322 or vice versa. The first force measuring device 323 provides a measuring range and an accuracy for measuring the first force, and the second force measuring device 324 provides a measuring range and an accuracy for measuring the second force. For measuring the first force the first force measuring device 323 is placed between the first support member 321 and the second support member 322 by moving the first support member 321 or the second support member 322 as shown in FIG. 3b). For measuring the second force the second force measuring device 324 is placed in direction of arrow 325 between the first support member 321 and the second support member 322 by moving the first support member 321 or second support member 322 (not shown). Thus, the first force measuring device 323 may be selected for measuring the first force, and the second force measuring device 324 may be selected for measuring the second force.

The measuring device 320 may further comprise an actuator (not shown). The actuator may be coupled to the first support member 321 and the second support member 322, and may place the first force measuring device 323 or the second force measuring device 324 between the first support member 321 and the second support member 322.

The measuring device 320 may further comprise one or more interlocks (not shown). An interlock may releasably couple the first force measuring device 323 or second force measuring device 324 to the first support member 321. For example, the first force measuring device 323 and second force measuring device 324, respectively, may dovetail with the first support member 321 when placed between the first support member 321 and the second support member 322.

FIG. 3c) shows a measuring device 330 comprising a first support member 331, a second support member 332, a first force measuring device 333 and a second force measuring device 334. The second force measuring device 333 is coupled to the first support member 331 and second support member 332. A first force, i.e. contact force, and a second force, i.e. residual unbalance, may act from the first support member 331 towards the second support member 332 or vice versa. The first force measuring device 333 provides a measuring range and an accuracy for measuring the first force, and the second force measuring device 334 provides a measuring range and an accuracy for measuring the second force. For measuring the first force the first force measuring device 333 is placed, substantially in parallel to the second force measuring device 334, between the first support member 331 and the second support member 332 as shown in FIG. 3c). Thus, the first force measuring device 333 may take a majority of the first force, and protect the second measuring device 334 from damage. Determination of the first force may combine measurements from the first force measuring device 333 and second force measuring device 334, compensate measurement from the first force measuring device 333 for a contribution from the second force measuring device 334, or disregard the contribution from the second force measuring device 334, particularly if the contribution is relatively small. For measuring the second force only the second force measuring device 334 is placed between the first support member 331 and the second support member 332 by moving the first measuring device 333 in direction of arrow 335 apart from the first support member 331 or second support member 332 (not shown). Thus, the first force measuring device 333 and, possibly, the second force measuring device 334 may be selected for measuring the first force, and the second force measuring device 334 may be selected for measuring the second force.

The measuring device 330 may further comprise an actuator (not shown). The actuator may be coupled to the first force measuring device 333, and may place the first force measuring device 333 between the first support member 331 and the second support member 332.

The measuring device 330 may further comprise one or more interlocks (not shown). An interlock may releasably couple the first force measuring device 333 to the first support member 331 and the second support member 332. For example, the first force measuring device 333 may dovetail with the first support member 331 and the second support member 332 when placed between the first support member 331 and the second support member 332.

FIG. 3d) shows a measuring device 340 comprising a first support member 341, a second support member 342, a force measuring device 344 and a first gauge member 346. The force measuring device 344 is coupled to the first support member 341 and second support member 342. A first force, i.e. contact force, and a second force, i.e. residual unbalance, may act from the first support member 341 towards the second support member 342 or vice versa. The force measuring device 344 provides a measuring range and an accuracy for measuring the second force. The first gauge member 346 provides the force measuring device 344 with a measuring range and an accuracy for measuring the first force. For measuring the first force the first gauge member 346 is placed, substantially in parallel to the force measuring device 344, between the first support member 341 and the second support member 342 as shown in FIG. 3d). Thus, the first gauge member 346 may take, in the given example, a majority of the first force, and protect the measuring device 344 from damage. Determination of the first force may scale measurement from the force measuring device 344 to compensate for a contribution from the first gauge member 346. For measuring the second force only the force measuring device 344 is placed between the first support member 341 and the second support member 342 by moving the first gauge member in direction of arrow 345 apart from the first support member 341 or second support member 342 (not shown). Thus, the second force measuring device 344 may be used for measuring the first force and the second force.

The measuring device 340 may further comprise an actuator (not shown). The actuator may be coupled to the first gauge member 346, and may place the first gauge member 346 between the first support member 341 and the second support member 342.

The measuring device 340 may further comprise one or more interlocks (not shown). An interlock may releasably couple the first gauge member 346 to the first support member 341 and the second support member 342. For example, the first gauge member 346 may dovetail with the first support member 341 and the second support member 342 when placed between the first support member 341 and the second support member 342.

The first gauge member 346 may comprise a first element and a second element, that surround the force measuring device 344.

The measuring device 340 may further comprise a second gauge member (not shown). The second gauge member may provide the force measuring device 344 with a measuring range and an accuracy for measuring the second force. The first gauge member 246 and the second gauge member may be used alternately or concurrently.

FIG. 3e) shows a measuring device 350 comprising a first support member 351, a second support member 352, a force first measuring device 353, a force second measuring device 354 and an inhibitor 357. The first force measuring device 353 is coupled to the first support member 351 and the second force measuring device 354. The second force measuring device 354 is further coupled to the second support member 352. A first force, i.e. contact force, and a second force, i.e. residual unbalance, may act from the first support member 351 towards the second support member 352 or vice versa. The first measuring device 353 provides a measuring range and an accuracy for measuring the first force. The second force measuring device 354 provides a measuring range and an accuracy for measuring the second force. The inhibitor 357 is an element, for example a rod, that is relatively rigid, i.e more rigid than the first force measuring device 353. For measuring the first force the inhibitor 357 is put, substantially in parallel, to the second force measuring device 354 as shown in FIG. 3e). Thus, the inhibitor 357 may take, in the given example, a majority of the first force, and protect the second measuring device 354 from damage. As the inhibitor 357 is more rigid than the first force measuring device 353, determination of the first force may use measurement from the first force measuring device 353. For measuring the second force the inhibitor 357 is put away from the second force measuring device 354, for example, by moving the inhibitor 357. The inhibitor 357 may be moved, for example by sliding or screwing, in direction of arrow 355 towards the first force measuring device 352 or in direction of arrow 358. Thus, the first force measuring device 353 may be used for measuring the first force, and the second force measuring device 354 may be used for measuring the second force.

The measuring device 350 may further comprise an actuator (not shown). The actuator may be coupled to the inhibitor 357, and may put the inhibitor 357 to the second force measuring device 354.

The measuring device 350 may further comprise one or more interlocks (not shown). An interlock may releasably couple the inhibitor 357 to the first force measuring device 353 and the second support member 352. For example, the inhibitor 357 may dovetail with the first force measuring device 353 and the second support member 352 when put between the first force measuring device 353 and the second support member 352.

The inhibitor 357 may comprise a first element and a second element, that surround the second force measuring device 354.

FIG. 3f) shows a measuring device 360 comprising a first support member 361, a second support member 362, a force first measuring device 363 and a force second measuring device 364. An axis is indicated by 369. The first force measuring device 363 is coupled to a first portion 361a of the first support member 361 and the second support member 362. The second force measuring device 364 is coupled to a second portion 361b of the first support member 361 and the second support member 362. A first force, i.e. contact force, may act from the first portion 361a of the first support member 361 towards the second support member 362 or vice versa. A second force, i.e. residual unbalance, may act from the second portion 361b of the first support member 361 towards the second support member 362 or vice versa. The first force and the second force act perpendicular to each other as shown in FIG. 3f). The first measuring device 363 provides a measuring range and an accuracy for measuring the first force. The second force measuring device 364 provides a measuring range and an accuracy for measuring the second force. As the first force and the second force act perpendicular to each other, the second measuring device 364 is protected from damage through the first force. Thus, the first force measuring device 363 may be used for measuring the first force, and the second force measuring device 364 may be used for measuring the second force, alternately or concurrently.

The measuring device 360 may be assigned to the rotational assembly 120; 220 comprising the axis 122; 222, that may receive and hold the vehicle wheel 130; 230 to be analysed as shown in FIGS. 1 and 2.

The measuring device 360 may be assigned to the drum assembly 140; 240 comprising the axis 142; 242 and the drum 143; 243 as shown in FIGS. 1 and 2. The measuring device 360 may be pivotable, such that the first force measuring device 363 may be used for measuring the first force between the tyre 132; 232 and the drum 143; 243, or the second force measuring device 364 may be used for measuring the second force between the tyre 132; 232 and the drum 143; 243.

While the measuring devices 310, 320, 330, 340, 350, 360 shown in FIG. 3a) to f) are described with reference to a force measuring devices, the measuring devices 310, 320, 330, 340, 350, 360 may, possibly with minor modifications, also be employed for measuring bending, mass, pressure, strain and other physical values, for example acceleration.

Although specific embodiments have been illustrated and described herein, it will be appreciated by those of ordinary skill in the art, that any arrangement which is calculated to achieve the same purpose may be substituted for the specific embodiments shown. It is to be understood, that the above description is intended to be illustrative and not restrictive. This application is intended to cover any adaptations or variations of the invention. Combinations of the above embodiments and many other embodiments will be apparent to those of skill in the art upon reading and understanding the above description. The scope of the invention includes any other embodiments and applications in which the above structures and methods may be used. The scope of the invention should, therefore, be determined with reference to the appended claims along with the full scope of equivalents to which such claims are entitled.

1. A method of analysing a vehicle wheel (130; 230) with a tyre (132; 232), comprising:
rotating the vehicle wheel (130; 230) with a first number of revolutions for a first period of time, wherein a tread surface (133; 233) of the tyre (132; 232) is pressed with a first force against a first rotatable drum (143; 243), the first force is measured with a first measuring device (145; 245; 310, 320, 330, 340, 350, 360), and the first force is kept substantially constant; and
rotating the vehicle wheel (130; 230) with a second number of revolutions for a second period of time, wherein the tread surface (133; 233) is pressed with a second force against the first drum (143; 243) or a second rotatable drum (253), and the second force is measured,
wherein:
the second force is less than the first force.

2. (canceled)

3. The method of claim 1, wherein:
the first force amounts to approximately between 100 N and 10 kN, approximately between 200 N and 5 kN, or approximately between 500 N and 2 kN;
the second force amounts to approximately between 1 N and 5 kN, approximately between 5 N and 1 kN, or approximately between 20 N and 200 N; or
both.

4. (canceled)

5. The method of claim 1, wherein:
the vehicle wheel (130; 230) is powered;
the first drum (143; 243) is powered;
the second drum (253) is powered;
or a combination thereof.

6. (canceled)

7. (canceled)

8. The method of claim 1, wherein:
the first force is measured with a first accuracy of approximately 10 N;
the second force is measured with a second accuracy of approximately 1 N; or
both.

9. (canceled)

10. The method of claim 1, wherein:
the first measuring device (145; 245; 310, 320, 330, 340, 350, 360) comprises a first force measuring device (313, 323, 333, 343, 353, 363) the second force being optionally measured with the first measuring device (145; 245; 310, 320, 330, 340, 350, 360);
a second measuring device (255) that comprises a second force measuring device, the second force being optionally measured with the second measuring device (255);
a first basic accuracy of the first measuring device (145; 245; 310, 320, 330, 340, 350, 360) is less than a second basic accuracy of the second measuring device (255); or
a combination thereof.

11. (canceled)

12. (canceled)

13. (canceled)

14. (canceled)

15. The method of claim 10, wherein:
the first measuring device (145; 245; 310, 320, 330, 340, 350, 360) is assigned to the vehicle wheel (130; 230);
the first measuring device (145; 245; 310, 320, 330, 340, 350, 360) is assigned to the first drum (143; 243);
the second measuring device (255) is assigned to the vehicle wheel (130; 230);
the second measuring device (255) is assigned to the first drum (143: 243);
the second measuring device (255) is assigned to the second drum (243); or
a combination thereof.

16. (canceled)

17. (canceled)

18. (canceled)

19. (canceled)

20. The method of claim 10, wherein:
the first measuring device (145; 245; 310, 320, 330, 340, 350, 360) and the second measuring device (255) are serially arranged;
the first measuring device (145; 245; 310, 320, 330, 340, 350, 360) and the second measuring device (255) are arranged in parallel;
the first measuring device (145; 245; 310, 320, 330, 340, 350, 360) is selectively operable to measure the first force;
the first measuring device (145; 245; 310, 320, 330, 340, 350, 360) is switchable between a first measuring range and a second measuring range;
the second measuring device (255) is selectively operable to measure the second force;
the second measuring device (255) is switchable between a third measuring range and a fourth measuring range;
the second force acts in a rotational plane of the vehicle wheel (130; 230) perpendicularly to the first force; or
a combination thereof.

21. (canceled)

22. (canceled)

23. (canceled)

24. (canceled)

25. (canceled)

26. (canceled)

27. The method of claim 1, wherein:
during rotating the vehicle wheel (130; 230) with the first number of revolutions a balancing substance is distributed in the tyre (132; 232), such that the vehicle wheel (130; 230) is balanced except for a residual unbalance; and
optionally, the residual unbalance is determined from the second force.

28. (canceled)

29. An apparatus (100; 200) for analysing a vehicle wheel (130; 230) with a tyre (132; 232), wherein:
the vehicle wheel (130; 230) is rotated with a first number of revolutions for a first period of time, wherein a tread surface (133; 233) of the tyre (132; 232) is pressed with a first force against a first rotatable drum (143; 243), the first force is measured with a first measuring device (145; 245; 310, 320, 330, 340, 350, 360), and the first force is kept substantially constant;
the vehicle wheel (130; 230) is rotated with a second number of revolutions for a second period of time, wherein the tread surface (133; 233) is pressed with a second force against the first drum (143; 243) or a second rotatable drum (253), and the second force is measured; and
the second force is less than the first force.

30. (canceled)

31. The apparatus (100; 200) of claim 29, wherein:
the first force amounts to approximately between 100 N and 10 kN, approximately between 200 N and 5 kN, or approximately between 500 N and 2 kN;
the second force amounts to approximately between 1 N and 5 kN, approximately between 5 N and 1 kN, or approximately between 20 N and 200 N; or
both.

32. (canceled)

33. The apparatus (100; 200) of claim 29, wherein:
the vehicle wheel (130; 230) is powered;
the first drum (143; 243) is powered;
the second drum (253) is powered; or
a combination thereof.

34. (canceled)

35. (canceled)

36. The apparatus (100; 200) of claim 29, wherein:
the first force is measured with a first accuracy of approximately 10 Nᵢ the second force is measured with a second accuracy of approximately 1 N; or
both.

37. (canceled)

38. The apparatus (100; 200) of claim 29, wherein:
the first measuring device (145; 245; 310, 320, 330, 340, 350, 360) comprises a first force measuring device; 313, 323, 333, 343, 353, 363, the second force being optionally measured with the first measuring device (145; 245; 310, 320, 330, 340, 350, 360);
a second measuring device (255) that comprises a second force measuring device, the second force being optionally measured with the second measuring device (255);
a first basic accuracy of the first measuring device (145; 245; 310, 320, 330, 340, 350, 360) is less than a second basic accuracy of the second measuring device (255); or
a combination thereof.

39. (canceled)

40. (canceled)

41. (canceled)

42. (canceled)

43. The apparatus (100; 200) of claim 38, wherein:
the first measuring device (145; 245; 310, 320, 330, 340, 350, 360) is assigned to the vehicle wheel (130; 230);
the first measuring device (145; 245; 310, 320, 330, 340, 350, 360) is assigned to the first drum (143; 243);
the second measuring device (255) is assigned to the vehicle wheel (130; 230);
the second measuring device (255) is assigned to the first drum (143; 243);
the second measuring device (255) is assigned to the second drum (243); or
a combination thereof.

44. (canceled)

45. (canceled)

46. (canceled)

47. (canceled)

48. The apparatus (100; 200) of claim 38, wherein:
the first measuring device (145; 245; 310, 320, 330, 340, 350, 360) and the second measuring device (255) are serially arranged;
the first measuring device (145; 245; 310, 320, 330, 340, 350, 360) and the second measuring device (255) are arranged in parallel;
the first measuring device (145; 245; 310, 320, 330, 340, 350, 360) is selectively operable to measure the first force;
the first measuring device (145; 245; 310, 320, 330, 340, 350, 360) is switchable between a first measuring range and a second measuring range;
the second measuring device (255) is selectively operable to measure the second force;
the second measuring device (255) is switchable between a third measuring range and a fourth measuring range;
the second force acts in a rotational plane of the vehicle wheel (130; 230) perpendicular to the first force; or
a combination thereof.

49. (canceled)

50. (canceled)

51. (canceled)

52. (canceled)

53. (canceled)

54. (canceled)

55. The apparatus (100; 200) of claim 29, wherein:
during rotating the vehicle wheel (130; 230) with the first number of revolutions a balancing substance is distributed in the tyre (132; 232), such that the vehicle wheel (130; 230) is balanced except for a residual unbalance; and
optionally, the residual unbalance is determined from the second force.

56. (canceled)
